(19) United States
(12) Patent Application Publication
(10) Pub. No.: US 2018/0328533 A1
(43) Pub. Date: Nov. 15, 2018

(54) TOOL-LESS LOCKING BASE MOUNT FOR A DISPLAY SUPPORT SYSTEM

(71) Applicant: Innovative Office Products, LLC, Easton, PA (US)

(72) Inventor: Peter J. Carrasquillo, Columbia, MO (US)

(21) Appl. No.: 15/975,419

(22) Filed: May 9, 2018

Related U.S. Application Data
(60) Provisional application No. 62/503,600, filed on May 9, 2017.

(51) Int. Cl. F16M 11/16; F16M 11/20; F16M 11/22

(52) U.S. Cl. CPC F16M 11/16; F16M 11/2014; F16M 11/126; F16M 2200/027; F16M 2200/08; F16M 11/22

(57) ABSTRACT

The present application discloses a tool-less locking base mount mechanism for a display support system for supporting electronic displays. The tool-less locking base mount mechanism permits repair or reconfiguration of this portion of the display support system without the need for tools. In one respect, the tool-less locking base mount comprises a locking lever having a cam portion including sidewall portions of different thicknesses.

### BACKGROUND

The present disclosure relates to a locking base mount for a display support system for supporting electronic displays (e.g., flat-screen monitors), and more particularly to a tool-less locking base mount for such an apparatus.

Display support systems are designed to support significant weight (e.g., the combined weight of multiple vertical columns, horizontal beam members, tilter assemblies, and monitors), and therefore must be strongly and safely secured to any supporting base members. Existing display support systems include upright columns that are fixedly attached to supporting base members by fasteners (e.g., machine screws), therefore requiring tools for disassembly. The need for tools slows down the repair and reconfiguration processes for these display support systems.

Accordingly, there is a need for a tool-less locking base mount for a display support system that addresses these and other drawbacks of the prior art.

### BRIEF DESCRIPTION OF THE DRAWINGS

The present embodiments will hereinafter be described in conjunction with the appended drawing figures, wherein like numerals denote like elements.

FIG. 1 is a perspective front view of a display support system according to the present disclosure;

FIG. 2 is a perspective rear view of the lower portion of the display support system of FIG. 1, showing the locking lever of the tool-less locking base mount mechanism;

FIG. 3 is a partial exploded view of the lower portion of the display support system of FIG. 1;

FIG. 4 is an exploded view of the tool-less locking base mount mechanism;

FIG. 5A is a sectional view taken along line 5-5 of FIG. 1, with the tool-less locking base mount mechanism in a locked position;

FIG. 5B is a sectional view taken along line 5-5 of FIG. 1, with the tool-less locking base mount mechanism in an unlocked position;

FIG. 6 is a sectional view taken along line 6-6 of FIG. 1, with the tool-less locking base mount mechanism in its locked position; and

FIG. 7 is a perspective view of the locking lever of the tool-less locking base mount mechanism.

### DETAILED DESCRIPTION OF THE PREFERRED EMBODIMENTS

The ensuing detailed description provides preferred exemplary embodiments only, and is not intended to limit the scope, applicability, or configuration of the present disclosure. Rather, the ensuing detailed description of the preferred exemplary embodiments will provide those skilled in the art with an enabling description for implementing the preferred exemplary embodiments of the present disclosure. It should be understood that various changes may be made in the function and arrangement of elements without departing from the spirit and scope of the invention, as set forth in the appended claims.

To aid in describing the embodiments in the present disclosure, directional terms may be used in the specification to describe portions of the embodiments (e.g., upper, lower, left, right, etc.). These directional definitions are merely intended to assist in describing and claiming the invention and are not intended to limit the invention, as set forth in the appended claims, in any way. In addition, reference numerals that are introduced in the specification in association with a drawing figure may be repeated in one or more subsequent figures without additional description in the specification in order to provide context for other features.

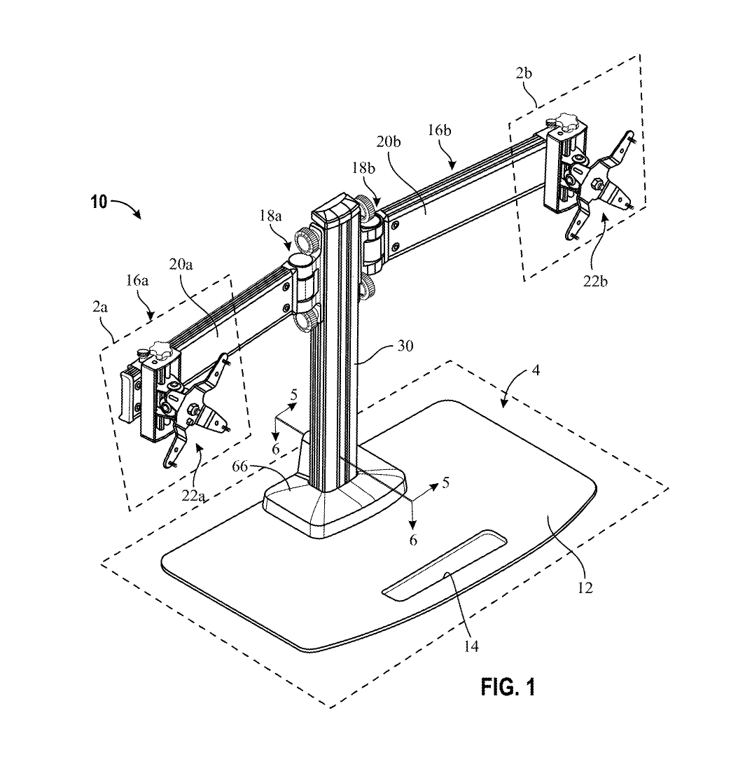

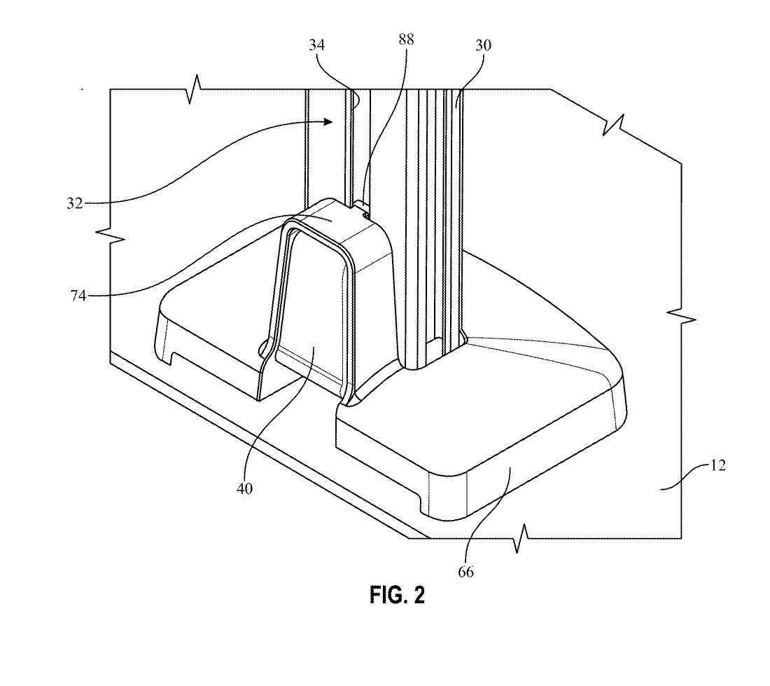

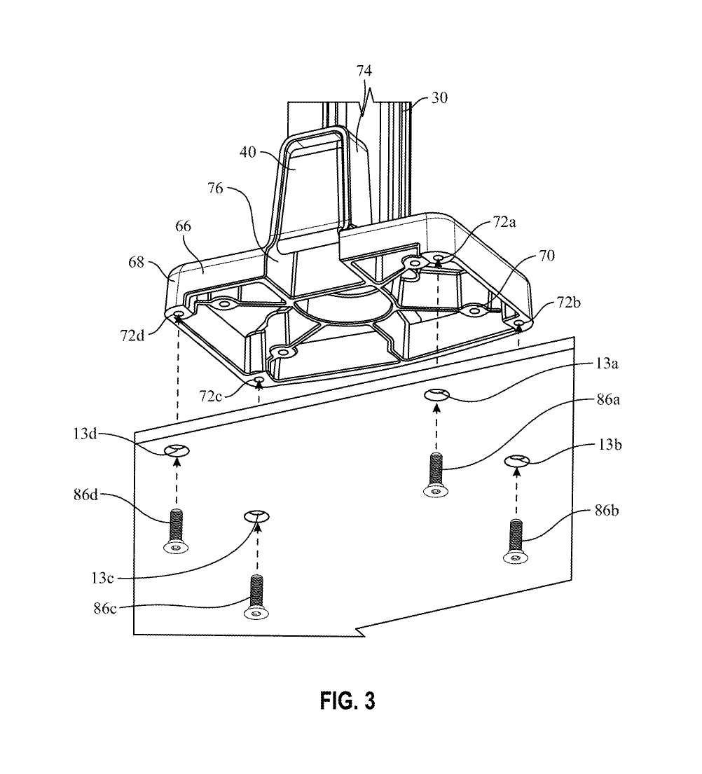

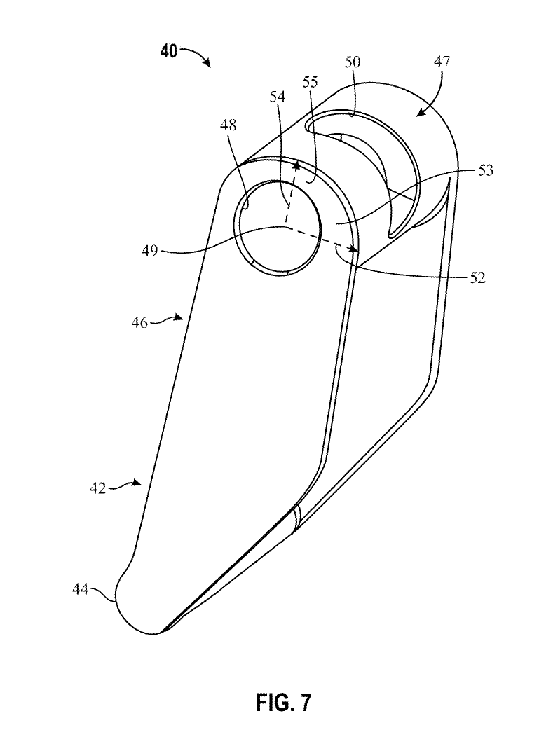

Referring generally to FIGS. 1-7, an embodiment of a display support system 10 according to the present disclosure will now be described in detail. In this embodiment, the system 10 comprises a base plate 12 that is designed to sit atop an existing worksurface 4, e.g., an existing desktop or tabletop, and support the system 10 from the existing worksurface 4. The existing worksurface 4 is shown schematically in FIG. 1. In this embodiment, the base plate 12 includes a hand slot 14 that permits the user to grab the system 10 by the hand slot 14 and slide the system 10 around atop the existing worksurface 4. The underside (not labeled) of the base plate 12 (see FIG. 3) may include a plurality of soft pads made of any known material to prevent damage to the existing worksurface 4 as the system 10 is moved around atop the existing worksurface 4.

In this embodiment, the system 10 comprises a pair of support beam assemblies 16a,16b that are rotatably attached to a column 30 via a respective one of a pair of hinges 18a,18b. Each of the hinges 18a,18b permits rotation of the respective support beam assembly 16a,16b about a generally-vertical axis (not labeled); i.e., these axes are each approximately parallel to the vertical, longitudinal axis (not labeled) of the column 30. Each support beam assembly 16a,16b comprises a respective one of a plurality of beam members 20a,20b, to which is attached a respective one of a plurality of display support assemblies 22a,22b. Each of the display support assemblies 22a,22b is used to support a respective electronic display 2a,2b and is movable along the length of the respective beam member 20a,20b so that the horizontal distances between the displays 2a,2b and the column 30 are adjustable. In alternate embodiments, an electronic display could be mounted directly or indirectly to the column 30 through any known means.

As will be described in further detail below, in this embodiment the column 30 is releasably attachable to a base member 66 via the tool-less locking mechanism 38 according to the present disclosure. As shown in FIG. 3, a base portion 68 of the base member 66 is attached to the base plate 12 via a plurality of fasteners 86a,86d, each of which is routed through a respective fastener hole 13a,13d located in the base plate 12 and into a respective fastener hole 72a-72d located on a bottom surface 70 of the base portion 68 of the base member 66.

In this embodiment, the column 30 is made of metal using an extrusion process, and has a uniform cross-sectional profile along its height. In alternate embodiments, the column 30 may be made of any other suitable material, and need not have a consistent cross-sectional profile along its height. The column 30 may also have any height within the scope of the present disclosure, and may accommodate any number of support beam assemblies and accompanying display support assemblies and/or displays.

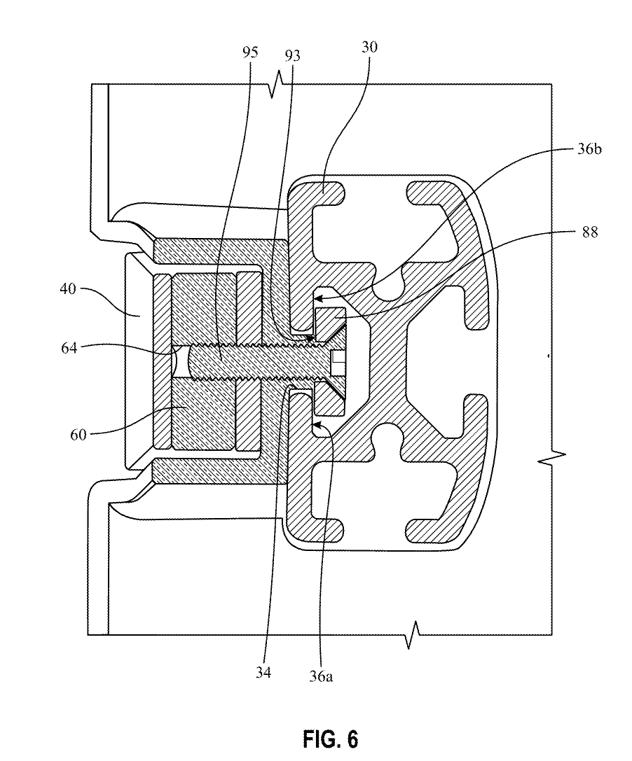

In the present embodiment, the column 30 comprises a rear side 32 including a slot 34, the slot 34 being sized to accommodate the placement of a clamping member (T-nut) 88 therein for supporting of the column 30 from the base member 66, as will be described in further detail below. The slot 34 includes a pair of slot inner surfaces 36a,36b (see FIG. 6) against which the T-nut 88 presses when the locking lever 40 is in its locked position.

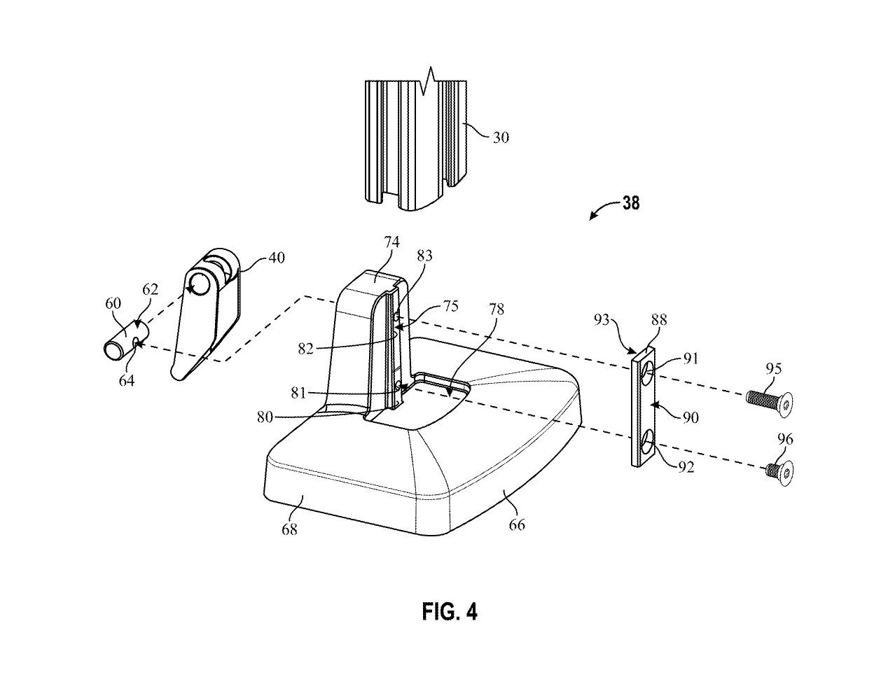

The base member 66 further comprises an upright portion 74 having an open rear portion 76 that accommodates placement of a locking lever 40 therein. As will be described below in further detail, the locking lever 40 is rotatable to adjust the tool-less locking mechanism 38 between its locked and unlocked positions. As shown in detail in FIGS. 4-7, the tool-less locking mechanism 38 is comprised of the base member 66, the T-nut 88, fastener 95, fastener 96, the locking lever 40, and a locking pin 60.

The base member 66 further comprises a surface 78 against which the column 30 is placed when the column 30 is installed on the base member 66. In this embodiment, the surface 78 is indented within the base portion 68 of the base member 66, so that the bottom end of the column 30 is supported within this indented region in contact with the surface 78 and prevented from sliding around on the base portion 68. The upright portion 74 of the base member 66 further comprises a front surface 75, which includes thereon a protruding flat surface 80 and a protruding angled surface 82 which fit within the slot 34 on the rear side 32 of the column 30. Flat surface 80 includes a fastener hole 81 therein, which in this embodiment includes internal threading. Angled surface 82 includes a fastener hole 83 therein, which in this embodiment is unthreaded.

T-nut 88 includes a front surface 90, a rear surface 93, fastener hole 91 for passage of fastener 95 therethrough, and fastener hole 92 for insertion of fastener 96 therein. T-nut 88 is fixedly attached to the upright portion 74 of the base member 66 by placing the rear surface 93 of the T-nut 88 against the flat surface 80 and routing the fastener 96 through fastener hole 92 in T-nut 88 and into the fastener hole 81 in the upright portion 74. Because fastener hole 81 in this embodiment includes internal threading, fastener 96 is fixedly attached to the upright portion 74. As seen in the Figures, in this embodiment fastener 96 is of a shorter length than fastener 95 and does not extend through the upright portion 74, although in alternate embodiments it could extend through the upright portion 74 without interfering with the functioning of the tool-less locking mechanism 38.

In this embodiment, fastener 95 and locking pin 60 are used to rotatably attach the locking lever 40 to the tool-less locking mechanism 38. Fastener 95 is routed through fastener hole 91 in T-nut 88, through the fastener hole 83 in the upright portion 74, and into a fastener hole 64 (containing internal threading) located in the locking pin 60. Fastener hole 83 is unthreaded, and therefore does not engage the length of the fastener 95 or hold the fastener 95 in place within the fastener hole 83. Locking pin 60 comprises an exterior surface 62, and the locking pin 60 is fitted within a locking pin passage 48 located in the locking lever 40 such that the exterior surface 62 is placed in contact with the interior surface of the locking pin passage 48. In this embodiment, except for the fastener hole 64, locking pin 60 is of cylindrical shape (i.e., having a circular cross-sectional area), and the locking pin passage 48 is of complementary shape.

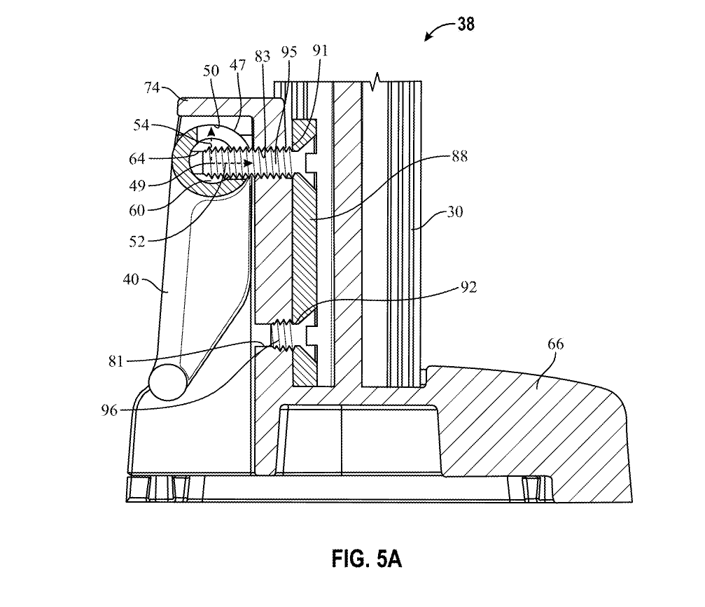

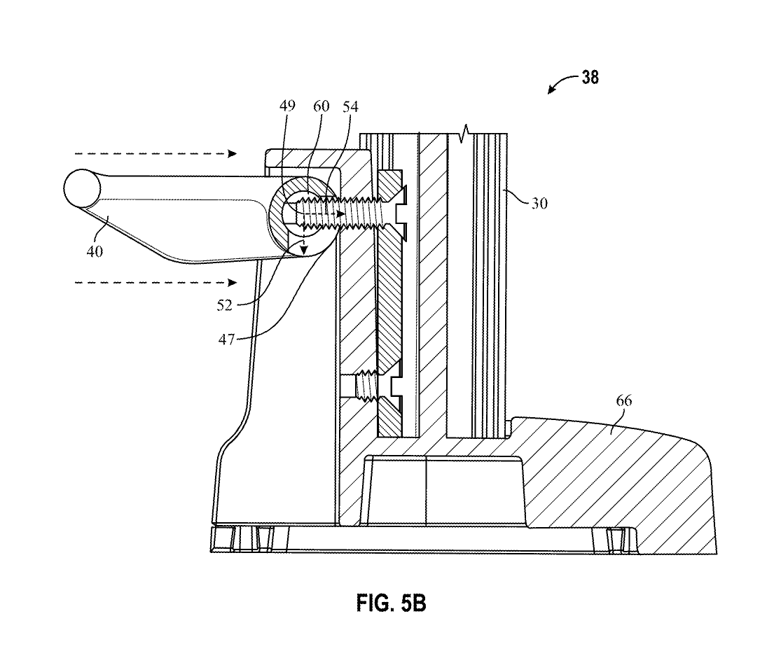

FIGS. 5A and 5B show sectional views of the tool-less locking mechanism 38 in, respectively, locked and unlocked positions. Locking lever 40 includes a fastener cutout 50 that permits locking lever 40 to be rotated between its locked and unlocked positions without interfering with fastener 95. In this embodiment, the locked and unlocked positions of the locking lever 40 are rotationally spaced approximately 90 degrees apart, although it should be understood that other rotational ranges between the locked and unlocked positions of the locking lever 40 are possible within the scope of this disclosure.

The end of the locking lever 40 that includes the locking pin passage 48 includes a cam portion 46 built therein, as will be described in greater detail below. The locking lever 40 further comprises a handle portion 42 that includes a grip portion 44 located at a bottom end thereof opposite the cam portion 46. In this embodiment, the grip portion 44 has a rounded cross-sectional profile, and the handle portion 42 of the locking lever 40 has a hollow rear side that comfortably permits the user to place their hand behind the locking lever 40 and pull it upwardly to move the locking lever 40 from its locked position (see FIG. 5A) to its unlocked position (see FIG. 5B).

In this embodiment, the cam portion 46 of the locking lever 40 includes a sidewall region 47 corresponding with the arc-length of the fastener cutout 50, the sidewall region 47 tapering from a first sidewall portion 53 of a maximum thickness to a second sidewall portion 55 of minimum thickness. Said another way, a first cam radius 52 is measured from a center axis 49 of the locking pin passage 48 to the exterior surface of the cam portion 46 corresponding with the first sidewall portion 53, a second cam radius 54 is measured from the center axis 49 to the exterior surface of the cam portion 46 corresponding with the second sidewall portion 55, and the first cam radius 52 is greater than the second cam radius 54. In this embodiment, the first cam radius 52 is approximately 15% larger than the second cam radius 54. In alternate embodiments, the first cam radius may be between 5-25%, or more preferably between 10-20%, larger than the second cam radius. It should also be understood that differences of greater than 25% between the first and second cam radii are possible within the scope of the present disclosure. Although in this embodiment the sidewall region 47 of the cam portion 46 tapers in thickness gradually between the first sidewall portion 53 and the second sidewall portion 55, in alternate embodiments the cam portion 46 need not taper in thickness but could instead step down gradually or suddenly in thickness between the two sidewall portions 53,55, such that the two sidewall portions 53,55 are not equal in thickness.

In the locked position of the locking lever 40, as shown in FIG. 5A, the first sidewall portion 53 is located such that it roughly corresponds with the axis of the fastener 95, and due to the larger thickness of the first sidewall portion 53, the fastener 95 is held tightly in place within the T-nut 88 and the fastener hole 64 within the locking pin 60. Further, in the unlocked position of the locking lever 40, the second sidewall portion 55 is aligned with the axis of the fastener 95.

As noted above, the rear side 32 of the column 30 includes a slot 34, which is sized to accommodate the placement of the T-nut 88 therein and which includes inner surfaces 36a,36b against which the rear surface 93 of the T-nut 88 presses when the locking lever 40 is in its locked position. Thus, when the tool-less locking mechanism 38 is in its locked position, the first sidewall portion 53 of the cam portion 46 of the locking lever 40, the fastener 95, and the T-nut 88 act together to clamp the T-nut 88 within the slot 34 of the column 30, thus rigidly holding the column 30 in place with respect to the base member 66.

When the locking lever 40 is rotated into its unlocked position, as shown in FIG. 5B, the second sidewall portion 55 is relocated such that it now roughly corresponds with the axis of the fastener 95. Due to the reduced thickness of the second sidewall portion 55 as compared to the first sidewall portion 53, in the unlocked position a space (see FIG. 5B) is created that allows for the fastener 95 to slide outwardly with respect to the T-nut 88 (i.e., roughly in the direction of the pair of arrows shown in FIG. 5B), thus removing the pressure that the T-nut 88 has been applying to the inner surfaces 36a,36b of the slot 34 of the column 30, and allowing for the column 30 to be removed from the base member 66 by lifting the column 30 upwardly until the slot 34 is free of the T-nut 88. Said another way, when the locking lever 40 is in its locked position, a head (not labeled) of the fastener 95 is in a first spatial relationship with respect to the fastener hole 91 in the clamping member (T-nut) 88, when the locking lever 40 is in its unlocked position, the head of the fastener 95 is in a second spatial relationship with respect to the fastener hole 91 in the clamping member (T-nut) 88, and a space is generated between the head of the fastener 95 and the fastener hole 91 in the clamping member (T-nut) 88 in the second spatial relationship (said space having either been smaller or non-existent in the first spatial relationship). The column 30 may be reinstalled onto the base member 66 by reversing these steps. The angled surface 82 permits for partial deformation of approximately the top half of the T-nut 88 when the locking lever 40 is placed in its locked position, thus aiding the clamping feature of the tool-less locking mechanism 38. The T-nut 88 would then return to its normal configuration once the locking lever 40 is placed into its unlocked position. Said another way, the locking lever 40 is adjustable between a locked position in which the at least one clamping member (T-nut) 88 applies sufficient pressure to the column 30 to maintain the column 30 in a fixed position with respect to the base member 66 and an unlocked position in which the pressure applied to the column 30 by the at least one clamping member (T-nut) 88 is reduced such that the column 30 may be removed from the base member 66. In the locked position, the at least one clamping member (T-nut 88) is moved firmly into contact with the inner surfaces 36a,36b of the column 30.

Thus, the tool-less locking mechanism 38 allows for the column 30, and all portions of the system 10 attached thereto, to be quickly and easily secured to or removed from the base member 66, without the need for screwdrivers, wrenches, or other tools, by rotating the locking lever 40, by hand, between locked and unlocked positions. It should also be appreciated that the present disclosure teaches a tool-less joining system employing the rotating locking lever 40 taught herein that could be employed to join together any two (or more) members in which one of the members is at least partially fitted within an interior portion of another member, wherein the locking mechanism 38 is used to releasably clamp the two members together.

While the principles of the disclosure have been described above in connection with preferred embodiments, it is to be clearly understood that this description is made only by way of example and not as a limitation of the scope of the disclosure.

1. A display support system for supporting at least one electronic display, the system comprising:
a base member;
a column that extends upwardly from the base member, the column being adapted to support the at least one electronic display therefrom; and
a locking mechanism that permits the column to be alternately secured to or released from the base member by hand, the locking mechanism comprising
a locking lever having a cam portion and a passage, the cam portion having a first sidewall portion having a first thickness and a second sidewall portion having a second thickness, the first thickness being greater than the second thickness,
a locking pin fitted within the passage, the locking pin comprising a hole,
at least one clamping member located within the column, and
at least one fastener that is attached between the hole in the locking pin and the at least one clamping member;
wherein the locking lever is adjustable between a locked position in which the at least one clamping member applies sufficient pressure to the column to maintain the column in a fixed position with respect to the base member and an unlocked position in which the pressure applied to the column by the at least one clamping member is reduced such that the column may be removed from the base member.

2. The display support system of claim 1, the cam portion of the locking lever further comprising a fastener cutout, the at least one fastener having an axis, wherein in the locked position of the locking lever the first sidewall portion is aligned with the axis and wherein in the unlocked position of the locking lever the second sidewall portion is aligned with the axis.

3. The display support of claim 1, further comprising a second fastener that fixedly secures a portion of the at least one clamping member to the base member.

4. The display support system of claim 1, wherein in the locked position the at least one clamping member is moved firmly into contact with an interior surface of the column.

5. The display support system of claim 1, the base member further comprising an upright portion having a hole through which the at least one fastener is routed, the upright portion being located between the cam portion of the locking lever and the at least one clamping member when the display support assembly is fully assembled.

6. The display support system of claim 5, further comprising a second fastener that fixedly secures a portion of the at least one clamping member to the upright portion of the base member.

7. The display support system of claim 5, the upright portion including at least one flat surface and at least one angled surface, the at least one angled surface including the hole through which the at least one fastener is routed, the at least one angled surface allowing for partial deformation of the at least one clamping member when the locking lever is placed in its locked position.

8. The display support system of claim 1, wherein the at least one fastener is fixedly attached at a first end to the locking pin via complementary threading, and wherein a second end of the at least one fastener passes through a hole in the at least one clamping member.

9. The display support system of claim 1, wherein the at least one fastener is fixedly attached at a first end to the locking pin via complementary threading, and wherein a second end of the at least one fastener passes through a hole in the at least one clamping member.

10. The display support system of claim 9, the at least one fastener further comprising a head located at the second end thereof, wherein in the locked position of the locking lever the head of the at least one fastener is in a first spatial relationship with respect to the hole in the at least one clamping member and in the unlocked position of the locking lever the head of the at least one fastener is in a second spatial relationship with respect to the hole in the at least one clamping member.

11. The display support system of claim 10, wherein a space is generated between the head of the at least one fastener and the hole in the at least one clamping member in the second spatial relationship.

12. The display support system of claim 1, wherein the cam portion tapers in thickness between the first thickness and the second thickness.

13. The display support system of claim 1, wherein the locking lever is adjustable between its locked position and its unlocked position by rotating the locking lever about the locking pin.

14. A tool-less locking base mount system for an electronic display support apparatus, the system comprising:
a first member including an interior portion;
a second member adapted to fit at least partially within the interior portion of the first member; and
a locking mechanism that permits the first member and second member to be secured together by hand when the second member has been fit at least partially within the interior portion of the first member, the locking mechanism comprising
a locking lever having a cam portion and a passage, the cam portion having a first sidewall portion having a first thickness and a second sidewall portion having a second thickness, the first thickness being greater than the second thickness,
a locking pin fitted within the passage, the locking pin comprising a hole,
at least one clamping member located within the interior portion of the first member, and
at least one fastener that is attached between the hole in the locking pin and the at least one clamping member;
wherein, when the second member has been fit at least partially within the interior portion of the first member, the locking lever is adjustable between a locked position in which the at least one clamping member applies sufficient pressure to the first member or the second member such that the first member and second member are maintained in a fixed spatial relationship with respect to another, and an unlocked position in which the pressure applied to the first member or the second member is reduced such that the second member may be fully removed from within the interior portion of the first member; and
wherein one of the first member and the second member is a column adapted to support at least one electronic display therefrom and the other of the first member and the second member is a base mount adapted to be supportable from an existing worksurface.

15. The system of claim 14, the cam portion of the locking lever further comprising a fastener cutout, the at least one fastener having an axis, wherein in the locked position of the locking lever the first sidewall portion is aligned with the axis and wherein in the unlocked position of the locking lever the second sidewall portion is aligned with the axis.

16. The system of claim 14, wherein the cam portion tapers in thickness between the first thickness and the second thickness.

17. A tool-less joining system, the system comprising:
a first member including an interior portion;
a second member adapted to fit at least partially within the interior portion of the first member; and
a locking mechanism that permits the first member and second member to be secured together by hand when the second member has been fit at least partially within the interior portion of the first member, the locking mechanism comprising
a locking lever having a cam portion and a passage, the cam portion having a first sidewall portion having a first thickness and a second sidewall portion having a second thickness, the first thickness being greater than the second thickness,
a locking pin fitted within the passage, the locking pin comprising a hole,
at least one clamping member located within the interior portion of the first member, and
at least one fastener that is attached between the hole in the locking pin and the at least one clamping member;
wherein, when the second member has been fit at least partially within the interior portion of the first member, the locking lever is adjustable between a locked position in which the at least one clamping member applies sufficient pressure to the first member or the second member such that the first member and second member are maintained in a fixed spatial relationship with respect to another, and an unlocked position in which the pressure applied to the first member or the second member is reduced such that the second member may be fully removed from within the interior portion of the first member.

18. The system of claim 17, the cam portion of the locking lever further comprising a fastener cutout, the at least one fastener having an axis, wherein in the locked position of the locking lever the first sidewall portion is aligned with the axis and wherein in the unlocked position of the locking lever the second sidewall portion is aligned with the axis.

19. The display support system of claim 17, wherein the locking lever is adjustable between its locked position and its unlocked position by rotating the locking lever about the locking pin.

20. The display support system of claim 17, wherein one of the first member and the second member is a column adapted to support at least one electronic display therefrom and the other of the first member and the second member is a base mount adapted to be supportable from an existing worksurface.
